(19) United States
(12) Patent Application Publication
(10) Pub. No.: US 2019/0061590 A1
(43) Pub. Date: Feb. 28, 2019

(54) MODIFIED TRAILER FOR THE TRANSPORTATION, QUICK LOADING AND UNLOADING OF GRANULATED MATERIALS

(71) Applicants: Eddy Kornelsen, Cuauhtemoc (MX); Jose Eliseo Meraz, Avondale, AZ (US)

(72) Inventors: Eddy Kornelsen, Cuauhtemoc (MX); Jose Eliseo Meraz, Avondale, AZ (US)

(21) Appl. No.: 16/038,725

(22) Filed: Jul. 18, 2018

(30) Foreign Application Priority Data
Aug. 29, 2017 (MX) MX/U/2017/000372

(51) Int. Cl. B60P 1/00; B60P 1/56

(52) U.S. Cl. CPC B60P 1/003; B65G 3/04; B60P 1/56

(57) ABSTRACT

The present invention consists of a modified trailer for the transportation, quick loading and unloading of granulated materials, which includes an ensemble of differently sized walls that, when put together, resemble a trapezoidal prism in shape. This trailer is fitted with a hatch located on its upper wall that's used for the loading of materials, as well as a discharge hatch that's designed for a quick and loss-free unloading of said material that avoids the generation of dust which is located in its lower wall. Additionally, it is also fitted with a wheel axle and a couple of support legs with a similar configuration to conventional load trailers.

### PURPOSE OF THE INVENTION

The present invention provides a means of transport that specifically consists of a modified trailer for the transportation, quick loading and unloading of granulated materials, which has been generated in response to the need of transporting raw materials of diverse kinds, having a number of specific modifications that ease in every step the trailer's loading and transported material's emptying processes.

### BACKGROUND

There exist a number of trailers for the hauling of materials that are well documented within the state of the art. Those commercialized under the Timpte, Wilson, and JetCo can be mentioned as examples. Relative to said conventional examples, the present invention differentiates itself, firstly, by its size, weight, shape and the fact that it is fitted with a chute that's coupled to an aperture mechanism that controls a discharge hatch by means of a manually-actioned lever that when cranked opens said hatch by means of a roller chain. This renders its opening more efficient and lessens the probability of failure by jamming. Secondly, the present trailer is fitted with a top-side covering that secures the transported materials. This covering incorporates a rectangular hatch that is used to load said trailer with the raw materials of interest, said hatch opens by means of a lever that is located in the rear part of the trailer.

### BRIEF DESCRIPTION OF THE DRAWINGS

FIG. 1 is a right side view of the modified trailer for the transportation, quick loading and unloading of granulated materials.

FIG. 2 is a rear view of the modified trailer for the transportation, quick loading and unloading of granulated materials.

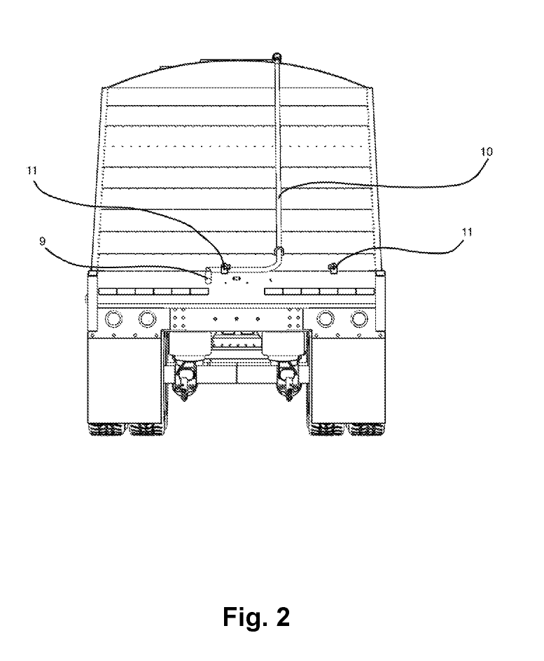

FIG. 3 illustrates the aperture and closing mechanism of the material discharge chute's hatch as well as the hatch itself.

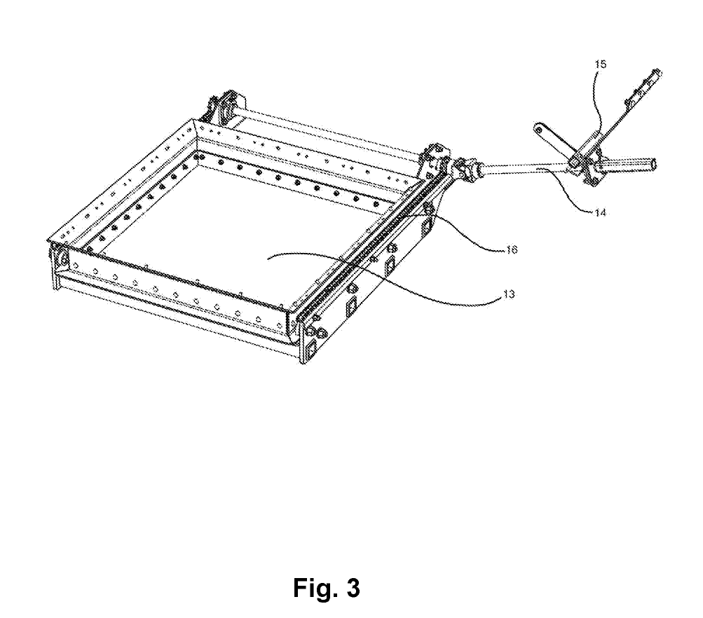

FIG. 4 is a transversal view of the modified trailer for the transportation, quick loading and unloading of granulated materials, at the point where the upper wall is joined with the rear wall.

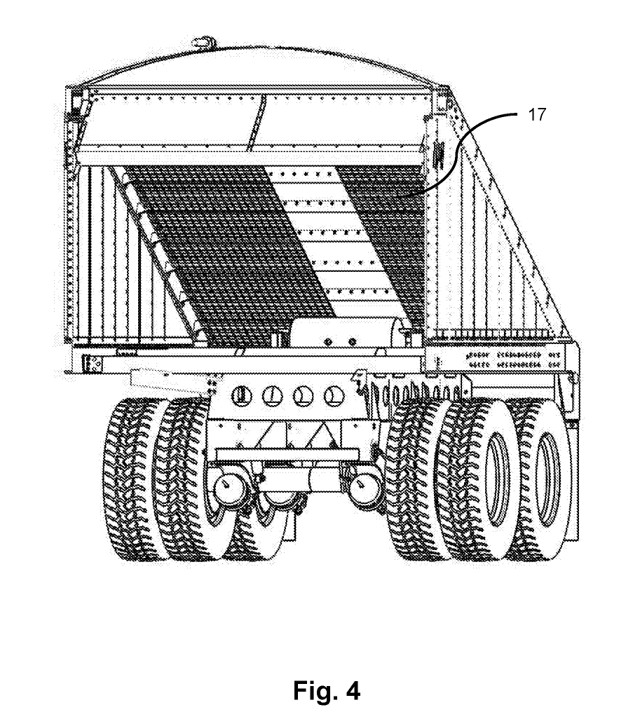

FIG. 5 is a transversal view of the modified trailer for the transportation, quick loading and unloading of granulated materials, at the point where the upper wall is joined with the forward wall.

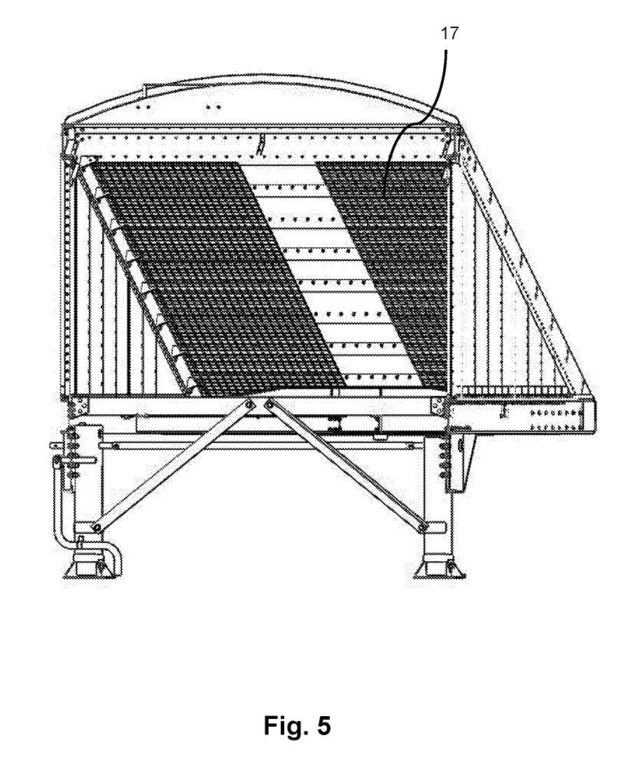

### DETAILED DESCRIPTION OF THE INVENTION

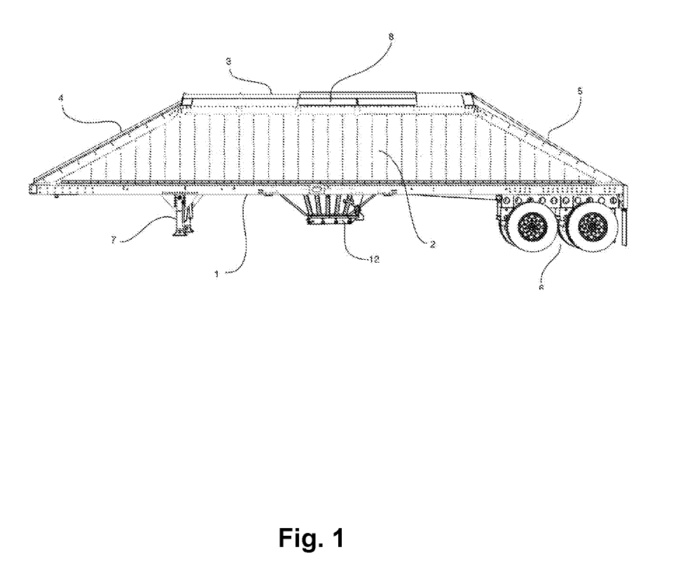

The present invention consists of a modified trailer for the transportation, quick loading and unloading of granulated materials, similar to a conventional trailer container, which consists of an ensemble of differently sized walls that, when put together, resemble a trapezoidal prism in shape, as is illustrated in FIG. 1. The modified trailer has a lower wall as a base (1), two same-sized lateral walls (2), an upper wall (3) smaller in size than the lower one, and same-sized forward (4) and rear (5) walls. The trailer's shape and construction materials allow for a lightweight ensemble that permits the hauling a greater amount of materials than existing trailer containers.

The trailer has a double axle (6) for wheels, located at its lower wall, as well as a pair of metallic support legs (7), perpendicular to said wall's surface, that are located near the longitudinal end opposite to the double axle, similar to a conventional trailer's configuration. These legs are necessary in order to support the present trailer when it is not docked to a truck.

The trailer's upper wall is completely covered by the same material that the whole trailer is made of There is a rectangular opening which is located at said upper wall's central part which is covered by a hatch (8). Said hatch can be designated as the loading hatch, and is used to load the trailer with the material intended to be hauled. It is opened and closed manually by means of a crank (9), which is located over the trailer's rear wall and has a longitudinal extension (10) that transmits the crank's motion to the hatch in order to open or close it.

This loading hatch is hooked to a couple of safeties (11) in order to prevent its opening when the trailer is being hauled or to prevent its closing during the loading process. There is a stairway located on the forward wall that can be used to access said loading hatch. There is a layer of diamond plate, preferably made of chromed aluminum, located next to the hatch that can be used to prevent the operator from falling when standing on top of the trailer and next to the loading hatch.

There is a chute attachment (12) located at the center of the lower wall that resembles an upside-down trapezoidal prism in shape. This attachment is fitted with a hatch (13) which is located at its inferior end, through which the materials contained within the trailer are unloaded. This discharge hatch is manually opened and closed by means of a lever (14) that is placed towards the left end of the hatch and is fastened with a hook (15) that acts as a safety. When the lever is turned, a conventional roller chain mechanism (16) that is placed on both sides of the discharge hatch helps it slide to an open or closed position.

Both the forward (4) and rear (5) walls have been fitted in their internal faces with nets (17), preferably made of metal, in order to protect the surface of said walls from an impact with any object during the hauling of the trailer.

The trailer's interior has two extra walls that extend from the upper front and upper rear edges towards the chute, with a 45-degree inclination and an overall shape resembling an upside-down trapezoidal pyramid. Said walls end where the chute begins, and achieve a hermetic space with a greater storage capacity and security than that in similar trailers.

A greater efficiency and security in the transportation of materials, as well as a quicker, safer and easier gravity-assisted discharge of said materials is achieved as a product of the ensemble's obtained shape. Discharge rates of, for example, 54,000 pounds of granulated material in 8 to 10 minutes can be achieved on a fully loaded trailer, which represents approximately a third of the time similar competing models take to perform the same operation. The present configuration of loading and discharge prevents in great measure the generation of dust, which is highly harmful towards human health and equipment infrastructure.

1. A modified trailer for the transportation, quick loading and unloading of granulated materials, comprising an ensemble of differently sized walls that, when put together, resemble a trapezoidal prism in shape, wherein the modified trailer has a lower wall as a base, two same-sized lateral walls, an upper wall smaller in size than the lower one, and same-sized forward and rear walls.

2. The trailer of claim 1, further comprising a double axle for wheels, located at its lower wall, as well as a pair of metallic support legs, perpendicular to said wall's surface, that are located near the longitudinal end opposite to the double axle.

3. The trailer of claim 1, further comprising a rectangular opening located at said upper wall's central part which is covered by a hatch; said hatch opened and closed manually by a crank located over the trailer's rear wall and having a longitudinal extension that transmits the crank's motion to the hatch in order to open or close it, wherein the hatch is hooked to a plurality of safeties in order to prevent its opening when the trailer is being hauled or to prevent its closing during the loading process.

4. The trailer of claim 1, further comprising a chute attachment located at the center of the lower wall that resembles an upside-down trapezoidal prism in shape, wherein the chute attachment is fitted with a hatch located at its inferior end, through which the materials contained within the trailer are unloaded, wherein the discharge hatch is manually opened and closed by means of a lever placed towards an end of the hatch and fastened with a hook that acts as a safety, and wherein when the lever is turned, a conventional roller chain mechanism on both sides of the discharge hatch helps it slide to an open or closed position.

5. The trailer of claim 1, further comprising forward and rear walls that include nets on their respective internal faces, wherein the nets are made of metal and protect the surface of said walls from an impact with any object during the hauling of the trailer.

6. The trailer of claim 1, further comprising two extra walls in its interior, extending from the upper front and upper rear edges towards the chute, with a 45 degree inclination and an overall shape resembling an upside-down trapezoidal pyramid, wherein said walls end where the chute begins.

7. A trailer for transporting granular material, comprising:
a pair of lateral walls, each lateral wall having a top lateral edge, front lateral edge, rear lateral edge, and lower lateral edge together forming a trapezoidal shape, wherein the top lateral edges are shorter than the lower lateral edges;
a lower wall spanning the lower lateral edges of the pair of lateral walls and having a front lower edge and a rear lower edge;
an upper wall spanning the top lateral edges of the pair of lateral walls and having a front upper edge and a rear upper edge;
a front wall spanning the front lower edge, front upper edge, and front lateral edges;
a rear wall spanning the rear lower edge, rear upper edge, and rear lateral edges;
a loading hatch positioned on the upper wall and configured to be mechanically opened and closed; and
a chute positioned on the lower wall.

8. The trailer of claim 7, wherein the chute comprises a discharge hatch configured to be mechanically opened and closed.

9. The trailer of claim 8, wherein the chute comprises outer walls forming a trapezoidal prism.

10. The trailer of claim 8, wherein the discharge hatch comprises a lever that, when rotated, causes the discharge hatch to open or close.

11. The trailer of claim 10, wherein the lever causes the discharge hatch to open or close by actuating at least one chain drive.

12. The trailer of claim 10, wherein the discharge hatch comprises a hook that, when engaged, prevents the lever from opening or closing the hatch.

13. The trailer of claim 7, wherein the loading hatch comprises a crank that, when rotated, causes the loading hatch to open or close.

14. The trailer of claim 13, wherein the crank is mechanically coupled to an extension that extends from the loading hatch to a location on the rear wall, and wherein rotation of the extension causes rotation of the crank.

15. The trailer of claim 14, wherein the extension includes a handle positioned proximate the rear lower edge.

16. The trailer of claim 15, wherein the rear wall includes at least one latch for maintaining the handle in a fixed position.

17. The trailer of claim 7, further comprising a first interior wall extending from the front upper edge to a front edge of the chute, and a second interior wall extending from the rear upper edge to a rear edge of the chute.

18. The trailer of claim 17, wherein the first and second interior walls are positions to direct a flow of granular material toward the chute.

19. The trailer of claim 7, further comprising a front net disposed on an inner surface of the front wall and a rear net disposed on an inner surface of the rear wall.

20. The trailer of claim 19, wherein the front and rear nets are made at least partially from metal.
